(19) United States
(12) Patent Application Publication
(10) Pub. No.: US 2025/0341886 A1
(43) Pub. Date: Nov. 6, 2025

(54) Walking Virtual Reality System

(71) Applicant: Kevin Jasper, South Boardman, MI (US)

(72) Inventor: Kevin Jasper, South Boardman, MI (US)

(21) Appl. No.: 19/197,388

(22) Filed: May 2, 2025

Related U.S. Application Data
(60) Provisional application No. 63/641,717, filed on May 2, 2024.

(51) Int. Cl. G06F 3/01; G09G 3/00; G09G 3/3208

(52) U.S. Cl. CPC G06F 3/012; G09G 3/001; G09G 3/3208; G09G 2320/0626; G09G 2354/00; G09G 2360/144

(57) ABSTRACT

A walking virtual reality system is provided. The system is comprised of a walking virtual reality system that comprises a VR headset and a mobile application to deliver immersive travel and fitness experiences. The headset features a durable, lightweight polycarbonate frame, high-resolution OLED micro displays offering vivid visuals, and multiple sensors, including an accelerometer, gyroscope, and proximity sensor, to enhance interaction and conserve energy. Spatial audio speakers and Bluetooth connectivity provide realistic soundscapes and flexible audio options, while a rechargeable battery and various connectivity ports ensure extended usability. The system's mobile application enables users to explore a library of virtual environments, track fitness metrics, and control the headset remotely, including voice commands and interactive features for personalized engagement. Together, these elements create a comprehensive AR/VR platform for enhanced walking or running activities.

### CROSS-REFERENCE TO RELATED APPLICATION

The present application claims priority to, and the benefit of, U.S. Provisional Application No. 63/641,717, which was filed on May 2, 2024, and is incorporated herein by reference in its entirety.

### FIELD OF THE INVENTION

The present invention relates generally to the field of virtual reality. More specifically, the present invention relates to a walking virtual reality platform featuring a VR headset with high-resolution displays, multiple sensors for interaction, spatial audio, and Bluetooth connectivity, alongside a rechargeable battery for extended use. A mobile application of the system allows users to explore virtual environments while walking and running, track fitness metrics, and control the headset remotely, creating an immersive experience for travel and fitness activities. Accordingly, the present disclosure makes specific reference thereto. Nonetheless, it is to be appreciated that aspects of the present invention are also equally applicable to other like applications, systems, and methods of manufacture.

### BACKGROUND

Many individuals face significant barriers to experiencing new and diverse environments due to physical, financial, or situational limitations. People with limited mobility, such as those with physical disabilities or chronic health conditions, are often unable to travel to places they wish to visit, leaving them disconnected from cultural, scenic, or recreational experiences. Financial constraints similarly prevent many individuals from vacationing in different locations, as the costs of transportation, lodging, and related expenses are often prohibitive. Furthermore, even routine activities such as exercising can become monotonous over time, leading individuals to seek ways to make their fitness routines more engaging and enjoyable. The lack of accessibility to stimulating environments—whether for leisure, cultural enrichment, or exercise—has a broader impact on mental well-being, motivation, and quality of life. Advances in technology, particularly in virtual reality, offer a promising avenue to address these challenges by simulating diverse and immersive environments. However, there remains a need for a comprehensive system that can integrate mobility, affordability, and engagement to cater to these diverse requirements.

Therefore, there exists a long-felt need in the art for a walking virtual reality system that enables individuals with limited mobility to experience diverse and engaging virtual locations from the comfort of their own homes. There also exists a long-felt need in the art for a walking virtual reality system that provides an affordable alternative for individuals to explore and enjoy the experience of travel without incurring significant expenses. Moreover, there exists a long-felt need in the art for a walking virtual reality system that enhances exercise routines by integrating unique, immersive environments to make physical activity more enjoyable and motivating.

The subject matter disclosed and claimed herein, in one embodiment thereof, comprises a walking virtual reality system. The system is comprised of a walking virtual reality system that comprises a VR headset and a mobile application to deliver immersive travel and fitness experiences. The headset features a durable, lightweight polycarbonate frame, high-resolution OLED micro displays offering vivid visuals, and multiple sensors, including an accelerometer, gyroscope, and proximity sensor, to enhance interaction and conserve energy. Spatial audio speakers and Bluetooth connectivity provide realistic soundscapes and flexible audio options, while a rechargeable battery and various connectivity ports ensure extended usability. The system's mobile application enables users to explore a library of virtual environments, track fitness metrics, and control the headset remotely, including voice commands and interactive features for personalized engagement. Together, these elements create a comprehensive AR/VR platform for enhanced walking or running activities.

In this manner, the walking virtual reality system of the present invention accomplishes all the forgoing objectives and provides a simulated walking experience in various virtual locations. The system synchronizes video recordings with user movement, creating an immersive and realistic travel experience. By interacting with earbuds and other smart devices, the walking virtual reality system enhances sensory engagement, delivering a multi-dimensional environment that stimulates the senses. This invention allows users to explore global destinations, improve workout experiences, and overcome physical or financial travel limitations, all within an accessible and user-friendly platform.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a walking virtual reality system comprising a virtual reality headset and a mobile application designed to deliver immersive travel and fitness experiences. The system integrates advanced hardware and software, simulating realistic environments, tracking fitness metrics, and enhancing user engagement during walking or running sessions.

The headset features a lightweight, durable polycarbonate frame with foldable arms for portability. It includes high-resolution OLED micro-display lenses offering 4K resolution per eye with a refresh rate of 90-120 Hz, ensuring vivid visuals and minimizing motion sickness. Sensors integrated into the headset track head movements, adjust the brightness based on ambient lighting, and detect when the device is removed to conserve power. Spatial audio speakers deliver synchronized 3D soundscapes, while Bluetooth connectivity supports external audio devices and interaction with the mobile application.

The headset is powered by a rechargeable lithium-ion battery with USB-C fast-charging capability and includes thermal management for safe operation. Connectivity options include a USB port for data transfer, a 3.5 mm audio jack for wired input, and user-friendly controls for navigation and operation. Advanced models may feature a front-facing camera for augmented reality functionality, overlaying virtual elements onto real-world environments.

The accompanying mobile application serves as the system's central interface, enabling users to select virtual environments, customize settings, and access a wide library of 360-degree immersive visuals. Features include a search function for tailored exploration, interactive elements offering contextual information, and a fitness tracker for monitoring steps, distance, and calories burned. The application integrates with wearable devices to enhance health data tracking and allows direct headset control via touch or voice commands.

Together, the headset and mobile application create a comprehensive, user-friendly platform for virtual reality travel, fitness, and entertainment, offering a seamless blend of hardware and software capabilities.

Accordingly, the walking virtual reality system of the present invention is particularly advantageous as it provides a simulated walking experience in various virtual locations. The system synchronizes video recordings with user movement, creating an immersive and realistic travel experience. By interacting with earbuds and other smart devices, the walking virtual reality system enhances sensory engagement, delivering a multi-dimensional environment that stimulates the senses. This invention allows users to explore global destinations, improve workout experiences, and overcome physical or financial travel limitations, all within an accessible and user-friendly platform.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of one potential embodiment of a walking virtual reality system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and systems are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a walking virtual reality system that enables individuals with limited mobility to experience diverse and engaging virtual locations from the comfort of their own homes. There also exists a long-felt need in the art for a walking virtual reality system that provides an affordable alternative for individuals to explore and enjoy the experience of travel without incurring significant expenses. Moreover, there exists a long-felt need in the art for a walking virtual reality system that enhances exercise routines by integrating unique, immersive environments to make physical activity more enjoyable and motivating.

The present invention, in one exemplary embodiment, is comprised of a walking virtual reality system that includes a virtual reality headset and a mobile application designed to provide immersive travel and fitness experiences. The system integrates advanced hardware and software to simulate realistic environments, track fitness metrics, and enhance user engagement during walking or running activities.

The headset features a lightweight, durable polycarbonate frame with foldable arms for ease of portability. It incorporates high-resolution OLED micro-display lenses delivering 4K resolution per eye with a refresh rate of 90-120 Hz, ensuring vivid visuals while reducing motion sickness. Sensors within the headset track head movements, adjust brightness according to ambient lighting, and detect removal to conserve power. Spatial audio speakers provide synchronized 3D soundscapes, and Bluetooth connectivity supports external audio devices and interaction with the mobile application.

A rechargeable lithium-ion battery powers the headset, with USB-C fast-charging capability and integrated thermal management for safe operation. Connectivity options include a USB port for data transfer, a 3.5 mm audio jack for wired input, and intuitive controls for navigation and operation. Advanced models may include a front-facing camera to enable augmented reality functionality by overlaying virtual elements onto real-world environments.

The mobile application functions as the system's central interface, allowing users to select virtual environments, customize settings, and access a comprehensive library of 360-degree immersive visuals. It features a search function for tailored exploration, interactive elements with contextual information, and a fitness tracker to monitor steps, distance, and calories burned. The application integrates with wearable devices to provide enhanced health data tracking and supports direct headset control through touch or voice commands.

The headset and mobile application together form a comprehensive, user-friendly platform for virtual reality travel, fitness, and entertainment, seamlessly combining hardware and software capabilities.

Accordingly, the walking virtual reality system offers significant advantages by providing a simulated walking experience across diverse virtual locations. The system synchronizes video content with user movement, creating a realistic and immersive travel experience. By integrating with earbuds and other smart devices, the system enhances sensory engagement, delivering a multi-dimensional environment that stimulates the senses. This invention enables users to explore global destinations, enhance workout routines, and overcome physical or financial barriers to travel within an accessible and user-friendly platform.

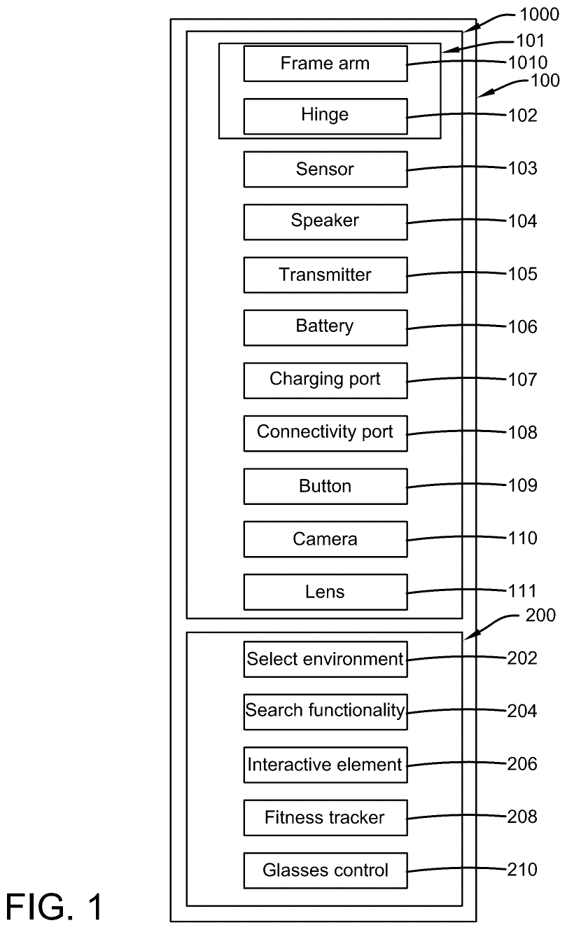

Referring initially to the drawings, FIG. 1 illustrates a graphical view of one potential embodiment of a walking virtual reality system 100 of the present invention in accordance with the disclosed architecture. The present invention is a walking virtual reality system 100 that provides a comprehensive solution for immersive travel and fitness experiences. The system 100 includes a virtual reality headset 1000 and an accompanying smartphone application 200. Together, the headset 1000 and application 200 create an integrated platform that combines advanced hardware and software to simulate realistic environments, track fitness progress, and enhance user engagement while walking or running. The components of the system 100 are graphically displayed in FIG. 1.

The VR headset 1000 features a durable and lightweight frame 101 preferably constructed from polycarbonate to ensure comfort and longevity during use. The polycarbonate material provides both rigidity and flexibility, ensuring the headset 1000 remains robust under repeated use while maintaining a lightweight profile for user comfort. The frame 101 is equipped with at least one hinge 102, allowing at least one frame arm 1010 to fold compactly. The hinge 102 is designed for durability to withstand frequent folding and unfolding, ensuring ease of portability without compromising structural integrity.

The headset 1000 includes at least one high-resolution OLED micro display lens 111 that delivers up to 4K resolution per eye. The lens 111 is designed to produce vivid, true-to-life visuals with high contrast ratios for a more immersive experience. Capable of refresh rates between 90-120 Hz, the lens 111 minimizes motion blur and reduces motion sickness, even during sessions involving rapid head movements.

The headset 1000 integrates at least one sensor 103, including but not limited to an accelerometer and gyroscope, to track head movements and orientation in real time. These sensors 103 enable users to explore 360-degree virtual environments by translating natural head movements into corresponding visual adjustments in the VR display. A proximity sensor 103 detects when the headset 1000 is removed from the user's head and automatically powers off the lens 111 to conserve battery life. An environmental light sensor 103 adjusts the brightness of the lens 111 dynamically based on ambient lighting conditions, ensuring a comfortable viewing experience in both dim and bright environments. These sensors 103 collectively enhance the usability and responsiveness of the headset 1000.

For audio functionality, the headset 1000 includes at least one spatial audio speaker 104 positioned near the temples. The speakers 104 delivers realistic 3D soundscapes synchronized with the visual content, such as the sound of ocean waves matching the user's perspective in a beach environment or the crunch of leaves underfoot in a forest setting. The sound quality is engineered to create a sense of depth and directionality, amplifying the immersive experience. The headset 1000 also includes a transmitter 105 for Bluetooth connectivity. The transmitter 105 enables the headset 1000 to pair with external headphones or earbuds for private listening and connects seamlessly with the mobile application 200 to synchronize audio, visual, and control signals. The speakers 104 may further deliver translated audio from locations where a user's non-native language is present.

The headset 1000 is powered by a rechargeable lithium-ion battery 106, designed for longevity and efficient power management. The battery 106 can be recharged via a USB-C charging port 107. The USB-C charging port 107 supports fast-charging technology. The inclusion of smart thermal management ensures the battery 106 and other components remain at safe operating temperatures, even during extended use.

Connectivity options of the headset 1000 include a connectivity port 108 in the form of a USB port for data transfer and a second port 108 in the form of a 3.5 mm audio jack for wired audio input. These ports 108 provide flexibility for users who prefer a wired setup or need to connect the headset 1000 to other devices for data sharing or firmware updates. At least one button 109 is integrated into the headset 1000 to allow the headset 1000 to be turned on or off and provides user-friendly controls for navigating menus, adjusting volume, and switching operational modes. Advanced models of the headset 1000 may include a front-facing camera 110 to enable augmented reality functionality. The camera 110 provides an additional layer of interaction by overlaying virtual elements onto real-world surroundings, creating a hybrid AR/VR experience.

The mobile application 200 acts as the central interface for the walking virtual reality system 100, offering a wide range of features to manage and customize the VR experience. Users can select from a comprehensive library of virtual environments using the select environment feature 202. This feature allows users to explore a variety of settings such as but not limited to any real-life destination, virtual setting, or in-world setting such as but not limited to Paris, New York City, the Great Wall of China, underwater, etc., all presented in high-quality 360-degree visuals that can be viewed while walking/running while wearing the headset 1000. The device can also be used for scenarios where a user needs to view locations for various purposes but are unable to currently visit said locations in person, such as but not limited to vacation destinations, house tours, golf courses, activities, etc. The application 200 includes search functionality 204, enabling users to locate specific environments based on keywords, themes, or categories such as but not limited to geographic location, seasons, etc. for a tailored experience.

To enhance engagement, the mobile application 200 supports interactive elements 206, such as pop-up information about landmarks, cultural details, or historical facts relevant to the selected environment. The interactive element 206 feature can be toggled on or off, allowing users to choose between an uninterrupted visual experience or an informative one. The application 200 also includes a fitness tracker 208, which records key metrics such as steps taken, distance covered, and calories burned during virtual sessions. The fitness tracker 208 is designed to integrate with wearable devices, providing additional health data such as heart rate and active time. Users can view detailed summaries of their fitness progress, track their achievements over time, and set personalized goals through the application 200.

The mobile application 200 allows for direct control of the VR glasses through the glasses control feature 210. This feature lets users adjust volume, switch virtual environments, or pause sessions directly from their smartphone, eliminating the need to remove the headset 1000 during use. The glasses control feature 210 also supports voice commands, enabling hands-free operation for added convenience.

By combining advanced hardware components such as the frame 101, lens 111, sensors 103, speakers 104, transmitter 105, battery 106, charging port 107, connectivity port 108, button 109, and optional camera 110 with the sophisticated functionality of the mobile application 200, including select environment 202, search functionality 204, interactive elements 206, fitness tracker 208, and glasses control 210, the walking virtual reality system 100 provides a fully integrated and immersive platform for virtual travel, fitness, and relaxation.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “walking virtual reality system” and “system” are interchangeable and refer to the walking virtual reality system 100 of the present invention.

Notwithstanding the forgoing, the walking virtual reality system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the walking virtual reality system 100 as shown in the FIGS. are for illustrative purposes only, and that many other sizes and shapes of the walking virtual reality system 100 are well within the scope of the present disclosure. Although the dimensions of the walking virtual reality system 100 are important design parameters for user convenience, the walking virtual reality system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A walking virtual reality system comprising:
a frame;
a micro display lens;
a sensor;
a speaker;
a battery;
a USB-C charging port;
a connectivity port;
a Bluetooth transmitter; and
a button.

2. The walking virtual reality system of claim 1, wherein the sensor is comprised of an accelerometer.

3. The walking virtual reality system of claim 1, wherein the sensor is comprised of a gyroscope.

4. The walking virtual reality system of claim 1, wherein the sensor is comprised of a proximity sensor.

5. The walking virtual reality system of claim 1, wherein the sensor is comprised of a light sensor.

6. The walking virtual reality system of claim 1, wherein the speaker is comprised of a spatial audio speaker.

7. The walking virtual reality system of claim 1, wherein the connectivity port is comprised of a USB port.

8. The walking virtual reality system of claim 1, wherein the connectivity port is comprised of a 3.5 mm audio jack port.

9. The walking virtual reality system of claim 5, wherein the light sensor adjusts a brightness of the micro display lens based on an ambient lighting condition.

10. A walking virtual reality system comprising:
a frame comprising a hinge and a frame arm, the hinge configured to allow folding of the frame arm;
a micro display lens;
a sensor;
a speaker;
a battery;
a charging port;
a connectivity port;
a Bluetooth transmitter; and
a button.

11. The walking virtual reality system of claim 10, wherein the sensor is comprised of an accelerometer.

12. The walking virtual reality system of claim 10, wherein the sensor is comprised of a gyroscope.

13. The walking virtual reality system of claim 10, wherein the sensor is comprised of a proximity sensor.

14. The walking virtual reality system of claim 10, wherein the sensor is comprised of a light sensor.

15. The walking virtual reality system of claim 10, wherein the speaker is comprised of a spatial audio speaker.

16. The walking virtual reality system of claim 10, wherein the connectivity port is comprised of a USB port.

17. The walking virtual reality system of claim 10, wherein the connectivity port is comprised of a 3.5 mm audio jack port.

18. A walking virtual reality system comprising:
a frame comprising a hinge and a frame arm, the hinge configured to allow folding of the frame arm;
an OLED micro display lens;
a sensor;
a speaker;
a rechargeable battery;
a USB-C charging port;
a connectivity port;
a Bluetooth transmitter; and
a button.

19. The walking virtual reality system of claim 18, wherein the sensor is comprised of an accelerometer, a gyroscope, a proximity sensor, or a light sensor.

20. The walking virtual reality system of claim 18, wherein the connectivity port is comprised of a USB port or a 3.5 mm audio jack port.
